(19) United States
(12) Patent Application Publication
(10) Pub. No.: US 2006/0180622 A1
(43) Pub. Date: Aug. 17, 2006

(54) Semi-rigid carrier

(76) Inventor: Timothy J. Dexter, Orland, CA (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/283,602

(22) Filed: Nov. 18, 2005

Related U.S. Application Data
(60) Provisional application No. 60/629,113, filed on Nov. 18, 2004.

(51) Int. Cl. B60R 9/00; B65D 25/00

(52) U.S. Cl. 224/314; 220/9.4; 224/318; 224/328

(57) ABSTRACT

Many drivers of vehicles transport cargo on the outside of their vehicles to increase the amount of space available inside the vehicle. Devices for transporting cargo in this manner must protect it from the wind and weather. The present disclosure is a carrier removably attachable to a vehicle. The carrier comprises a collapsible container having an exterior surface and an interior surface, the collapsible container capable of being removably attached to the vehicle, a cargo storage area defined by the interior surface at least one pocket located on the exterior surface, and at least one rigid member inserted into the at least one pocket, wherein the at least one rigid member permits the collapsible container to go from a collapsed storable position to a rigid cargo carrying position.

### CROSS-REFERENCE TO RELATED APPLICATIONS

This application claims priority from U.S. Provisional Patent Application No. 60/629,113 filed on Nov. 18, 2004, which is hereby incorporated by reference.

### FIELD OF THE INVENTION

The present invention is generally related to carriers attachable to a vehicle, and more particularly to a carrier attachable a vehicle that comprises a collapsible container that can go from a collapsed storable position to a rigid cargo carrying position.

### BACKGROUND

Today, many vehicles are equipped with roof or truck lid racks upon which various cargo items, such as luggage, boxes, sleeping bags, camping equipment, ski equipment, etc., may be transported. Many of these cargo items are wind or water sensitive, or have shapes that prevent them from being individually attached or bundled with other cargo items and attached to the rack. In order to transport these cargo items on the rack, they first may be placed inside a larger carrier capable of being attached to the rack or otherwise to the outside of the vehicle.

There are known in the art numerous devices for carrying and transporting cargo and luggage on the outside of vehicles. Such devices are intended to transport cargo, luggage, and other items in a manner that protects them from the wind and weather, while securing them to outside of the vehicle, particularly the roof of the vehicle. The art primarily discloses rigid body devices in which to place cargo items. One particular drawback with such cargo carriers is that the solid bodied component cannot be stored in a compact manner, is difficult to ship and store, and tends to be large and bulky. Alternatively, the art discloses soft body devices in which to place cargo items. A drawback to these is that they are easily broken into, can flap in the wind resulting in premature wear, and often do not provide significant protection from the weather.

### SUMMARY

Accordingly, the present invention provides a carrier removably attachable to a vehicle. The carrier comprises a collapsible container having an exterior surface and an interior surface, the collapsible container capable of being removably attached to the vehicle, a cargo storage area defined by the interior surface at least one pocket located on the exterior surface, and at least one rigid member inserted into the at least one pocket, wherein the at least one rigid member permits the collapsible container to go from a collapsed storable position to a rigid cargo carrying position.

In yet another embodiment, a carrier attachable to a vehicle is shown. The carrier comprises a collapsible container having first and second side portions and a bottom portion, a first pocket located on the first side portion, a second pocket located on the second side portion, a third pocket located on the bottom portion, first and second rigid members inserted into said first and second pockets respectively, wherein said first and second rigid members permit the collapsible container to go from a collapsed storable position to a rigid cargo carrying position, and a frame member capable of insertion into the bottom pocket.

In still yet another embodiment, a method of assembling a carrier is disclosed. The method comprises unfolding a collapsible container having first and second side portions, a bottom pocket, and a support pocket wherein the first and second side portions each include a pocket, assembling a frame member, inserting the frame member into the bottom pocket, inserting at least one rigid member into at least one of the pockets of the first and second side portions, positioning the first and second side portions so the collapsible container goes from a collapsed storable position to a rigid cargo carrying position, and inserting a support member in the support pocket to retain the collapsible container in the rigid cargo carrying position.

Additional information will be set forth in the description which follows, and in part will be obvious from the description, or may be learned by practice of the invention.

### DESCRIPTION OF THE DRAWINGS

For a better understanding of the descriptions disclosed herein reference may be made to the following illustrations, wherein:

FIG. 1 is a view of an embodiment of a carrier of the present invention in a collapsed state and secured to a vehicle roof;

FIG. 2 is a view of an embodiment of the carrier in a rigid cargo carrying position and attached to the vehicle roof;

FIG. 3 is view of frame members of an embodiment of the carrier partially inserted into a bottom pocket of the carrier;

FIG. 4 is a partial view of a bottom corner of an embodiment of the carrier;

FIG. 5 is a top view of an embodiment of the carrier with the rigid members partially inserted into the side pockets;

FIG. 6 is a partial view of an air dam of an embodiment of the carrier;

FIG. 7 is a partial view of an embodiment of the carrier in a rigid cargo carrying position;

FIG. 8 is a view of a support member pocket with a support member partially inserted therein and a closure strip opened of an embodiment of the carrier;

FIG. 9 is a partial view of the support member pocket with the closure strip closed;

FIG. 10 is a side view of an embodiment of the carrier in the rigid cargo carrying position;

FIG. 11 is a top view of an embodiment of the carrier with a rain slipper attached thereto;

FIG. 12 is a partial view of a side of the carrier; and

FIG. 13 is a partial view of a bottom corner of an embodiment of the carrier in a collapsed storable position.

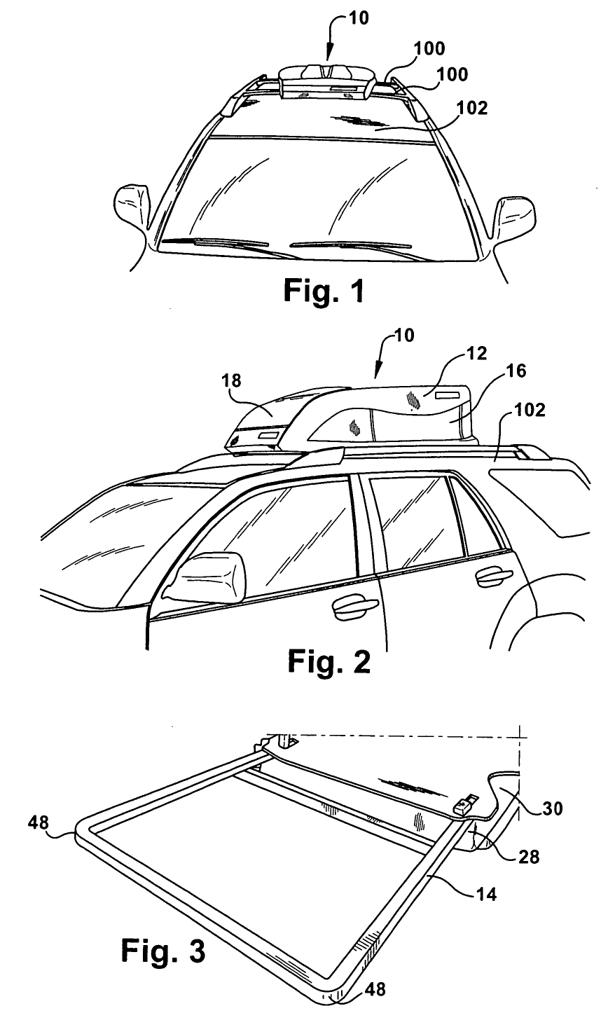

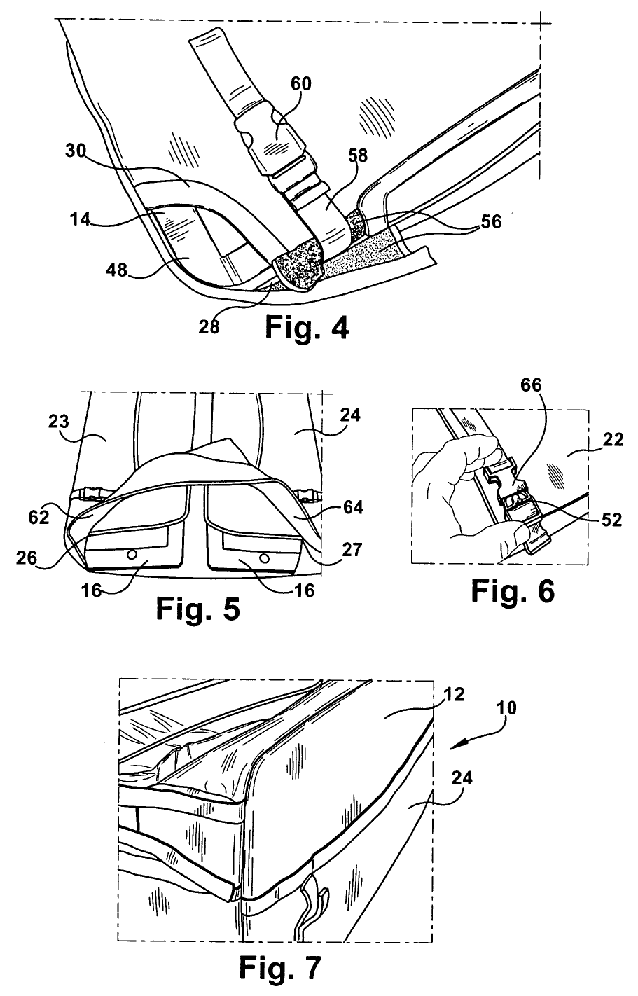

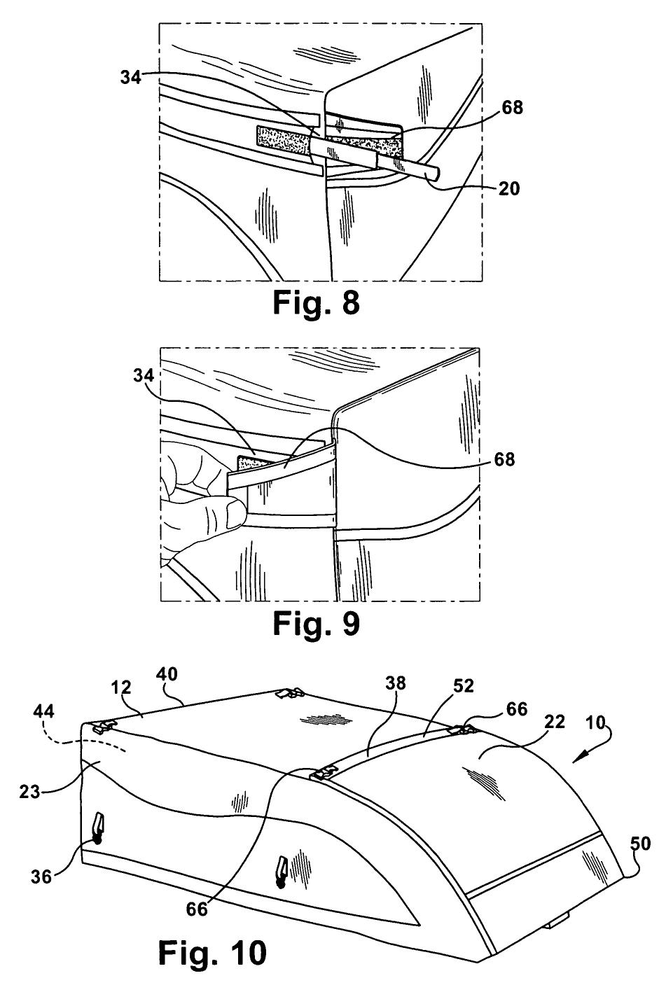

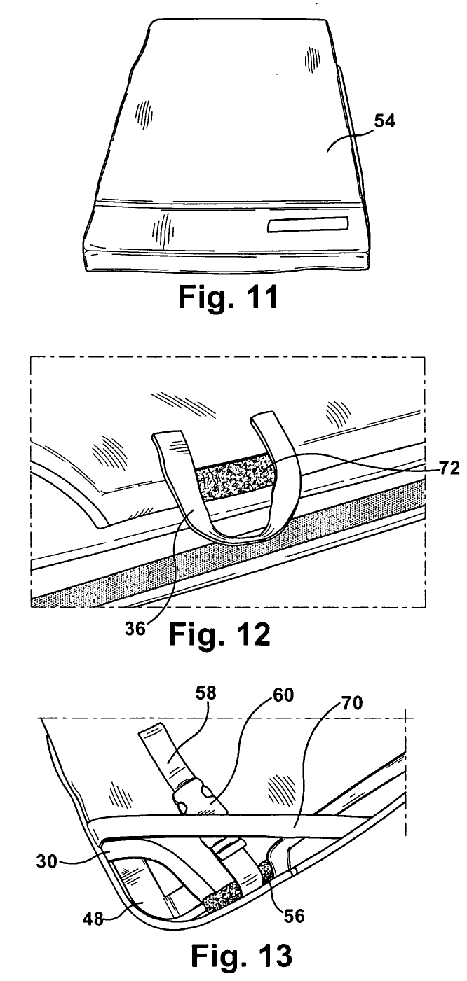

### DETAILED DESCRIPTION

While the present invention is described with reference to the preferred embodiment, it should be clear that the present invention should not be limited to this embodiment. Therefore, the description of the preferred embodiment herein is illustrative of the present invention and should not limit the scope of the invention as claimed.

Reference will now be made to the drawings where there is provided a semi-rigid carrier, generally designated 10, for transporting and protecting cargo items carried on the outside of a vehicle. The carrier 10 comprises a collapsible bag 12, a frame member 14, at least one rigid member 16 (there are two shown in the drawings), a support member 20, and an air dam 22.

The collapsible bag 12 can be made from a non-rigid, durable, waterproof material such as nylon, Gore-Tex®, or any other generally water resistant flexible material. The collapsible bag 12 can take any shape, not just the rectangular shape shown in the drawings. For example, the collapsible bag 12 could be circular, elliptical, square, triangular, polygonal, etc. The collapsible bag 12 includes a first side portion 23 and a second side portion 24. Each side portion 23, 24 includes a pocket 26, 27 capable of receiving the rigid members 16. The collapsible bag 12 further includes a bottom pocket 28 with cutouts 30 located in each corner thereof and also includes a rear support member pocket 34.

The rigid members 16 can be made of any non-corrosive material such as fiberglass, plastic, rubber, non-corrosive metal (aluminum, stainless steel, etc.), wood, etc. The material should allow the rigid member 16 to remain rigid and stiff. Further, the rigid members 16 may take any shape that substantially corresponds to the shape of the pockets 26, 27, such as circular, elliptical, rectangular, or any other polygonal shape. As shown in the drawings, the rigid members 16 are shown as rectangular panels with portions cut out so as to make the rigid members 16 lighter, although they need not have such portions cut-out. The rigid members 16 of any other shape may also have portions thereof cut out (have material removed) so as to make such rigid members 16 lighter. Finally, despite two rigid members 16 being shown in the drawings, one rigid member 16 may be used to maintain the collapsible bag 12 sufficiently rigid to hold its rigid cargo carrying position. In such a situation one rigid member is inserted into one of the side pockets 26, 27. It should also be understood that any number of rigid members 16 may be used. Additional pockets can be added to the side portions 23, 24 to accommodate the additional rigid members 16. In such a case, the rigid members 16 may take a variety of shapes, for example, two rectangular rigid members 16 can be insertable into two rectangular pockets and one circular rigid member can be insertable into a circular pocket, etc.

To assist with manually carrying the carrier 10, the collapsible bag 12 may further include side grab handles 36. The side grab handles 36 are attached to the first and second side portions 23, 24 of the collapsible bag 12 by means of gluing, heat welding, sewing, etc. Finally, the collapsible bag 12 includes a front openable/closeable opening 38 and a rear openable/closeable opening 40 to provide access to the interior of the collapsible bag 12, or more specifically to provide access to the storage area 44 of the bag 12. The front and rear openable/closeable opening 38, 40 may include a zipper, Velcro, snaps, or some other device to permit the openings 38, 40 to be openable and closeable.

The frame member 14 can be made from any non-corrosive material such as fiberglass, plastic, rubber, non-corrosive metal (aluminum, stainless steel, etc.), wood, etc. The frame member 14 is of a shape that substantially corresponds to the shape of the collapsible bag 12. More specifically, in the present embodiment, the frame member 14 shape corresponds to the shape of the bottom pocket 28 of the collapsible bag 12, which are both substantially rectangular. The frame member 14 is insertable into the bottom pocket 28 so that the edges 48 of the frame member 14 extend through the cutouts 30 of the bottom pocket 28. The cutouts 30 make it easier to install the frame member 14 into the bottom pocket 28 and make it easier to withdraw the frame member 14 from the bottom pocket 28. Additionally, the edges 48 of the frame member 14 can be used to attach the carrier 10 to a vehicle.

The support member 20 can made from any non-corrosive material such as fiberglass, plastic, rubber, non-corrosive metal (aluminum, stainless steel, etc.), wood, etc. The support member 20 will have a shape that substantially corresponds to that of the support member pocket 34. As shown in the drawings, this is a substantially rectangular shape, where the support member 20 is significantly longer than it is wide. It should be understood that the support member 20 is not limited to the shape shown in the figures. It can take a variety of other polygonal shapes as well as circular or elliptical shapes. Additionally, as with the rigid member 16, the support member 20 can have portions thereof cut out of it (or material removed therefrom) so as to make it lighter. Finally, the support member 20 can be a batten, although any sort of support member can be used.

As previously stated, the carrier 10 may further include the air dam 22. The air dam 22 assists with the aerodynamics of the carrier 10 when it is attached to the outside of the vehicle. More specifically, when the carrier 10 is attached to the roof of the vehicle, the air dam 22 will decrease the wind resistance against the carrier 10, thus increasing the gas mileage for the vehicle. The air dam 22 is attached to the collapsible bag 12 by a first end 50 of the air dam 22 being attached with the collapsible bag 12 by sewing, heat welding, gluing, or some other method. A second end 52 of the air dam 22 is removably attached to the collapsible bag 12 by Velcro, a strap, a buckle, snap, button, or other devices. The air dam 22 can be made of fiberglass, plastic, rubber, or non-corrosive metal (aluminum, stainless steel, etc.).

Finally, the carrier 10 may include a rain slipper 54. The rain slipper 54 provides additional protection from the elements, such as rain, snow, and sleet. The rain slipper 54 can be made from any sort of generally water resistant/repellant material. It is attachable to the collapsible bag 12 by Velcro, straps, buckles, snaps, buttons, or other devices.

To assemble the carrier 10, the collapsible bag 12 is unfolded and laid flat with the bottom side facing up. Next, the frame member 14 is assembled and inserted into the bottom pocket 28 of the bag 12. The front edges 48 of the frame member 14 are inserted through the cutouts 30 of the bottom pocket 28. Velcro straps 56 are used to close the bottom pocket 28, and as shown two Velcro straps 56 are used to close the open end of the pocket 28, to prevent the frame member 14 from falling out. Finally, security straps 58 with buckles 60 are then secured to prevent the Velcro straps 56 from coming undone, thus, further securing the frame member 14 in the bottom pocket 28. It should be understood, however, that any sort of device can be used to close the open end of the pocket 28, not just the Velcro straps 56 disclosed above. Further any sort of security device can be used, not just the security straps 58 with buckles disclosed above.

To further assemble the carrier 10, the rigid side members 16 are inserted into the side pockets 26, 27 on the first and second side portions 23, 24 of the bag 12. The rigid side portions 16, therefore, permit the carrier 10 to become upstanding in its rigid cargo carrying position. Once the rigid members 16 are inserted into the side pockets 26, 27, Velcro straps 62, 64 are closed so as to prevent the rigid members 16 from falling out of the side pockets 26, 27. Next, the first and second side portions 23, 24 are pivoted so as to stand up the first and second side portions 23, 24. The second end of the air dam 22 is then attached to the bag 12 by using buckles 66. The air dam 22 may be attached to the bag 12 by any means, not just the buckle. For example, a Velcro strap may be used, a snap, a tie strap, etc.

The support member 20 is next inserted into the support member pocket 34. A closure flap 68 is used to not only close and secure the support member 20 in the support member pocket 34, but it can also be used as a lever to assist in the insertion of the support member 20 into the support member pocket 34. Once this is complete, the carrier 10 can be secured to the vehicle. In particular, the carrier 10 can be placed on top of the transverse rails 100 on the vehicle roof 102, i.e., the luggage rack on top of the vehicle. The carrier 10 can be removably secured to the luggage rack by using two “J” bolts per connection, and a spanner plate and knobs (not shown). Alternatively, the carrier 10 can be attached in any conventional manner.

Once secured to the vehicle, the carrier 10 is ready for loading of cargo items. Any sort of item can be loaded therein and be protected from the outdoor elements such as rain, snow, sleet, sun, wind, etc. Once the carrier 10 is loaded, the operator of the vehicle can now drive the vehicle with the cargo loaded and secured to the vehicle.

Once the carrier 10 is no longer required for use, it can be collapsed, while remaining secured to the vehicle. In order to collapse the carrier 10, the support member 20 is removed from the support member pocket 34. The support member 20 can then be stowed in a safe place for future use. Next, the air dam 22 can be disconnected by, for example, unbuckling the air dam 22 and tucking all of the material of the bag 12 under the first and second side portions 23, 24. Then, the air dam buckle 66 and the buckles 60, can be secured by using, for example, a strap 70 that prevents the buckles 60, 66 from flapping in the wind. Finally, the rain slipper 54 can be installed and the straps 70 can be run under the transverse rails 100 of the vehicle. The user can also hide the side grab handles 36 if he or she so desires by raising the handles 36 and closing a Velcro rain fly 72 over the top of the handles 36. The carrier 10, therefore, is in a collapsed storable position that is resistant to the elements and, most particularly, creates less wind resistance than an un-collapsible system.

Modification of the invention will occur to those skilled in the art and to those who make or use the invention. It is understood that the embodiments shown in the drawings and described above are merely for illustrative purposes and not intended to limit the scope of the invention, which is defined by the following claims as interpreted according to the principles of patent law, including the Doctrine of Equivalents.

Having thus described the invention, I claim:

1. A carrier removably attachable to a vehicle, said carrier comprising:
a collapsible container having an exterior surface and an interior surface, said collapsible container capable of being removably attached to said vehicle;
a cargo storage area defined by said interior surface;
at least one pocket located on said exterior surface; and
at least one rigid member inserted into said at least one pocket, wherein said at least one rigid member permits said collapsible container to go from a collapsed storable position to a rigid cargo carrying position.

2. The carrier of claim 1, wherein said collapsible container comprises a bag.

3. The carrier of claim 1, wherein said collapsible container further includes a bottom pocket located on said exterior surface.

4. The carrier of claim 3, further comprising a frame member capable of insertion into said bottom pocket.

5. The carrier of claim 4, wherein said collapsible container further includes a support pocket located on said exterior surface.

6. The carrier of claim 5, further including a support member inserted into said support pocket, wherein said support member retains said collapsible container in said rigid cargo carrying position.

7. The carrier of claim 6, wherein said collapsible container is capable of removable attachment to a roof of said vehicle.

8. The carrier of claim 7, further including an air dam attached to said exterior surface of said collapsible container to decrease drag on said collapsible container.

9. The carrier of claim 8, wherein said collapsible container is substantially waterproof.

10. The carrier of claim 9, further comprising a rain slipper.

11. A carrier attachable to a vehicle, said carrier comprising:
a collapsible container having first and second side portions and a bottom portion;
a first pocket located on said first side portion;
a second pocket located on said second side portion;
a third pocket located on said bottom portion;
first and second rigid members inserted into said first and second pockets respectively, wherein said first and second rigid members permit said collapsible container to go from a collapsed storable position to a rigid cargo carrying position; and
a frame member capable of insertion into said bottom pocket.

12. The carrier of claim 11, wherein said collapsible bag further includes at least one closeable opening.

13. The carrier of claim 12, wherein said at least one closeable opening comprises a zippered opening.

14. The carrier of claim 11, wherein said collapsible bag further includes a front portion having a zippered opening and a rear portion having a zippered opening.

15. The carrier of claim 14, wherein said collapsible bag further includes at least one handle.

16. The carrier of claim 11, wherein said collapsible bag includes a support pocket on an end thereof.

17. The carrier of claim 16, further including a support member inserted into said support pocket, wherein said support member retains said collapsible container in said rigid cargo carrying position.

18. A method of assembling a carrier, the method comprising:
unfolding a collapsible container having first and second side portions, a bottom pocket, and a support pocket wherein said first and second side portions each include a pocket;
assembling a frame member;
inserting said frame member into said bottom pocket;
inserting at least one rigid member into at least one of said pockets of said first and second side portions;
positioning said first and second side portions so said collapsible container goes from a collapsed storable position to a rigid cargo carrying position; and
inserting a support member in said support pocket to retain said collapsible container in said rigid cargo carrying position.

19. The method of claim 18, further comprising removably attaching said collapsible container to a roof of a vehicle.

20. The method of claim 19, further comprising attaching an air dam to the collapsible bag to decrease drag on said collapsible bag.
